(19) United States
(12) Patent Application Publication
(10) Pub. No.: US 2007/0288854 A1
(43) Pub. Date: Dec. 13, 2007

(54) Reusable XForms processor

(75) Inventor: Oskari Koskimies, Helsinki (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/451,485

(22) Filed: Jun. 13, 2006

(51) Int. Cl. G06F 3/00; G06F 7/00; G06F 17/00

(52) U.S. Cl. 715/760; 715/513; 707/100; 715/505

(57) ABSTRACT

Systems and methods are provided for invoking user interface (UI) functionality by a client application. Data is received from a server, such as a web server, parsed and used to create a hierarchy of application UI objects. A corresponding hierarchy of XForms objects is created, such that each XForms object maps to an application UI object. The user interface is rendered at the client display by displaying objects in the application UI objects hierarchy and invoking the corresponding functionality from the XForms object hierarchy.

### BACKGROUND

The present disclosure relates to systems and methods for providing form controls in a user interface (UI), such as XForms documents. XForms is an Extensible Markup Language (XML) format for the specification of user interfaces, specifically web forms. XForms may be integrated into HyperText Markup Language (HTML) or Extensible HyperText Markup Language (XHTML) forms, or may be used in a standalone manner to describe any user interface, and even may perform common data manipulation tasks. An XForms document, or XHTML document containing references to XForms objects, may be rendered as a simple web form in an HTML document in which the form controls are placed in the body of the document. Alternatively, an XForms document may include more advanced features, such as validating against XML schema data types, requiring certain data in certain UI form fields, disabling input controls or changing sections of the form depending on circumstances, and responding to actions in real time rather than at submission time. Thus, XForms UI functionality may reduce or even eliminate the need for the application to provide UI handler scripts for managing the UI appropriately for the certain application. Refer to the World Wide Web Consortium (W3C) published or recommended XForms Specifications (e.g., XForms 1.0 Second Edition) for additional information about the XForms format or specific XForms objects.

XForms functionality is often implemented as an XForms processor installed on a client computer. For example, an XForms plugin executable may be installed to execute within a web browser on a client computer. Thus, the XForms functionality may be dependent on the browser and any underlying software components, such as the Document Object Model (DOM) component integrated into the client application (e.g., browser). This dependency results in potentially different behaviors in XForms UI functionality based on the different client application or DOM implementation on the client computer. Thus, XForms user interface functionality may ultimately be dependent on the particular version and/or implementation of client software components such as DOM.

One solution to this problem is simply to use the same client software configuration every time a certain XForms UI functionality is invoked. For example, a web page user interface may use several XForms control objects which are reusable as long as the client computer accessing and submitting the form controls uses the same predetermined browser and XForms plugin. However, this solution might not be practical since various client applications may select different DOM implementations based on the application requirements or preferences, or a client application might not use a DOM implementation at all.

Another solution is illustrated in FIG. 1. A Forms Processor Engine 101 uses a Scheme File 102 and Forms Library Functions 103-105 to implement portions of form control behaviors, such as data processing, parsing, and submission. However, under this solution, the form UI control functionality must be provided by the application itself in UI handlers 106-108, rather than by the Forms Processor Engine 101, Scheme File 102, or Forms Library Functions 103-105. Application-specific forms control functionality might permit for greater reusability of the application, but may require considerable effort on the part of application developers, for example to write script for each of the required UI handlers 106-108. Requiring applications to provide the UI related functionality also defeats a major purpose of XForms, to automatically provide useful UI related functionality and allow applications to easily invoke that functionality rather than rewriting it.

Accordingly, there remains a need for methods and systems for invoking functionality related to form controls in a user interface.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

According to one aspect of the present disclosure, a user interface including a set of objects, such as Html objects and XForms objects, is displayed by a client application. The user interface may be represented as an object hierarchy created based on a markup language data file. A corresponding XForms structure is generated to provide user interface (UI) functionality, such as functionality associated with the UI forms objects in the object hierarchy. The user interface may be displayed by rendering forms objects from the object hierarchy and invoking forms functionality from the corresponding XForms structure.

According to another aspect of the present disclosure, the XForms structure that provides forms functionality for the user interface may be connected to the application UI object hierarchy by two-way pointers linking associated XForms objects. XForms objects may navigate logical links to interact with related XForms objects by communicating with the associated application UI object and traversing the application UI object hierarchy to identify the child/parent objects of a given XForms object. Traversal of the application UI object hierarchy initiated by an XForms object may disregard any non-XForms object, so that accurate child-parent relationships may be considered just among the XForms objects, if desired. According to yet another aspect of the present disclosure, an XForms object may access the associated application UI form object to: access the UI form control properties, update the UI form control with new data, add or remove items from the UI form control, and send and receive events associated with the UI form control.

Thus, according to some aspects of the present disclosure, user interface forms functionality may be associated with a structure outside of the application UI object hierarchy. Such a structure may have improved reliability and reusability characteristics for invoking functionality related to form controls in a user interface, since the forms functionality may be less dependent on, or even completely independent of, the client application and software component implementations such as DOM installed on the client machine.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating a conventional technique for performing forms user interface functionality;

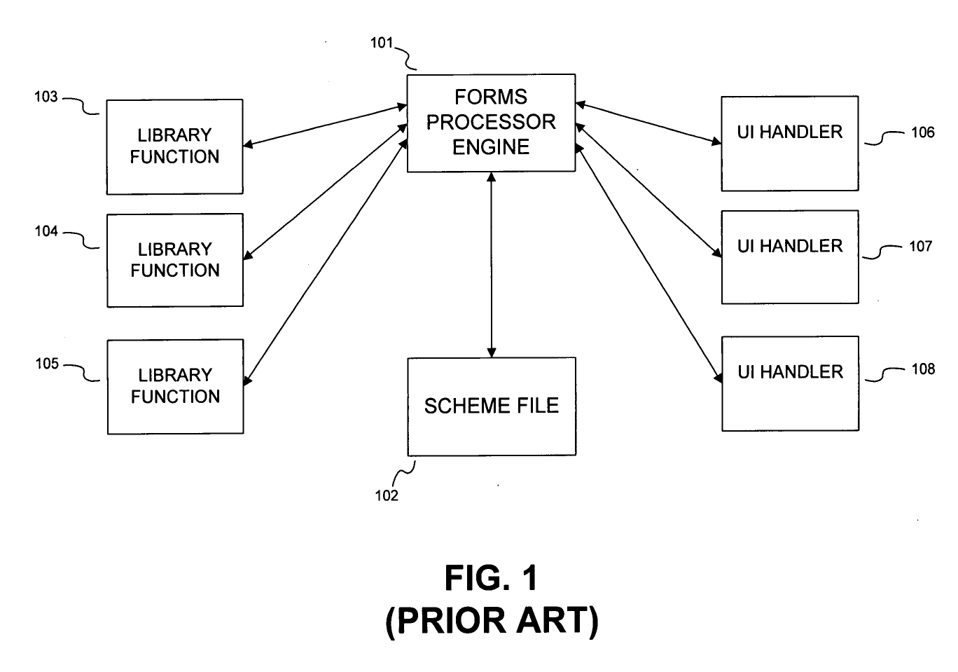

FIG. 2 is a block diagram illustrating a computing device, in accordance with aspects of the present disclosure;

FIG. 3 is a flow diagram showing illustrative steps for performing forms user interface functionality, in accordance with aspects of the present disclosure;

FIG. 4 is a block diagram showing an illustrative object hierarchy relating to performing forms user interface functionality, in accordance with aspects of the present disclosure; and

FIG. 5 is a flow diagram showing illustrative steps for performing a search/navigation function in an object hierarchy, in accordance with aspects of the present disclosure.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

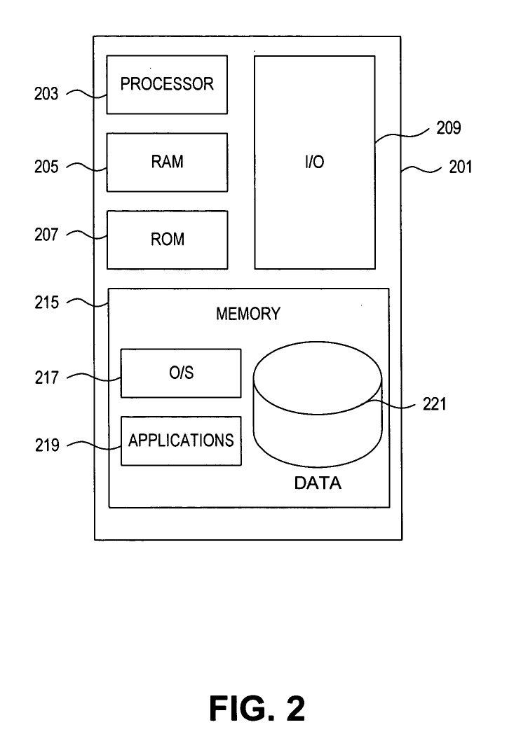

FIG. 2 illustrates a block diagram of a generic computing device 201 that may be used according to an illustrative embodiment of the invention. Device 201 may have a processor 203 for controlling overall operation of the computing device and its associated components, including RAM 205, ROM 207, input/output module 209, and memory 215.

I/O 209 may include a microphone, keypad, touch screen, and/or stylus through which a user of device 201 may provide input, and may also include one or more of a speaker for providing audio output and a video display device for providing textual, audiovisual and/or graphical output.

Memory 215 may store software used by device 201, such as an operating system 217, application programs 219, and associated data 221. For example, one application program 221 used by device 201 according to an illustrative embodiment of the invention may include computer executable instructions for invoking user interface functionality, such as UI forms functionality, and logic as described herein.

Device 201 may also be a mobile terminal including various other components, such as a battery, speaker, and antennas (not shown). I/O 209 may include a user interface including such physical components as a voice interface, one or more arrow keys, joy-stick, data glove, mouse, roller ball, touch screen, or the like. In this example, the memory 215 of mobile device 201 may be implemented with any combination of read only memory modules or random access memory modules, optionally including both volatile and nonvolatile memory and optionally being detachable. Software may be stored within memory 215 and/or storage to provide instructions to processor 203 for enabling mobile terminal 201 to perform various functions. Alternatively, some or all of mobile terminal 201 computer executable instructions may be embodied in hardware or firmware (not shown).

Additionally, a mobile terminal 201 may be configured to send and receive transmissions through various device components, such as an FM/AM radio receiver, wireless local area network (WLAN) transceiver, and telecommunications transceiver (not shown). In one aspect of the invention, mobile terminal 201 may receive radio data stream (RDS) messages. Mobile terminal 201 may be equipped with other receivers/transceivers, e.g., one or more of a Digital Audio Broadcasting (DAB) receiver, a Digital Radio Mondiale (DRM) receiver, a Forward Link Only (FLO) receiver, a Digital Multimedia Broadcasting (DMB) receiver, etc. Hardware may be combined to provide a single receiver that receives and interprets multiple formats and transmission standards, as desired. That is, each receiver in a mobile terminal 201 may share parts or subassemblies with one or more other receivers in the mobile terminal device, or each receiver may be an independent subassembly.

The illustrative generic computing device or mobile terminal 201 described in FIG. 2 may support potential advantages when displaying user interfaces according to a format such as XForms. For example, when an XForms processor executes on a mobile device 201, the user interfaces displayed may require fewer server round trips to display, update, and submit data in the user interface.

Another potential advantage of the present disclosure relates to using a user interface format such as XForms on a mobile device 201. Since the capabilities of different mobile terminals may vary greatly, the work involved in generating different user interfaces for different devices may be considerable. XForms is designed to allow forms to be described independently of the physical specifications of device 201, thus reducing the amount of work required to create and display user interfaces with forms on multiple devices 201. Yet another potential advantage of the present disclosure relates to the reduced need for client execution of scripts, such as JavaScript, when using XForms or a similar user interface format. Since scripting support varies widely on different mobile terminals 201, XForms allows for the execution of different functionality on different mobile terminals 201, reducing or even eliminating the reliance on device dependent scripting support.

While the present disclosure often refers specifically to XForms technology, it is understood that the aspects and advantages described herein are not limited to XForms. Potentially any user interface functionality, that is, functionality that affects what is shown on a user interface, which may depend on an operating system, browser, or other software component installed on a client computer, might be made more reliable and reusable by using a component design similar to the XForms-related processor and object hierarchies described in the present disclosure. In particular, aspects of the present disclosure may be beneficial in cases where one markup language with user interface functionality is embedded into another markup language, e.g. SVG (Scalable Vector Graphics) may be embedded into HTML.

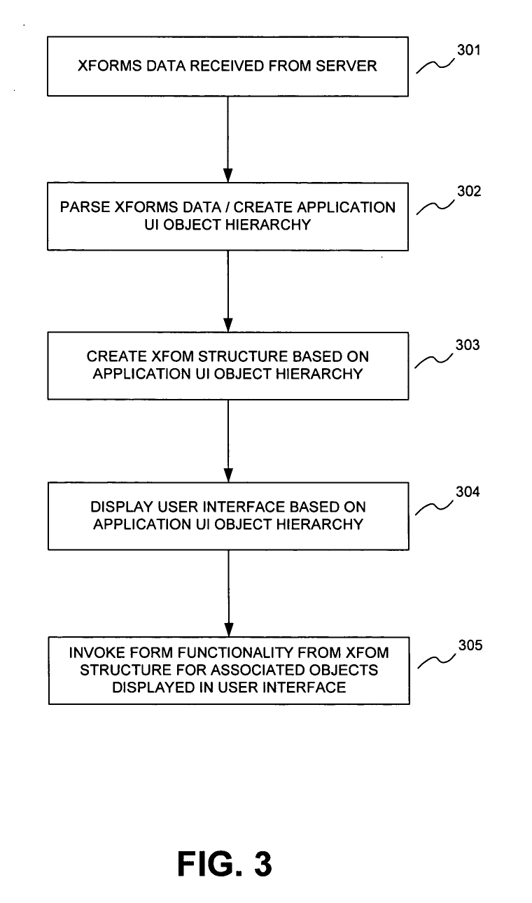

Referring to FIG. 3, a flow diagram is shown illustrating steps for performing forms user interface functionality. In step 301, data is received from a server at a client computer for rendering and displaying by a client application. For example, a browser application running on the client computer may receive data from a server in response to a client request, for example, a user opening a web page. The data received by the browser may be formatted according to a markup language, for example a Standard Generalized Markup Language (SGML) such as the commonly used HyperText Markup Language (HTML), or a stricter Extensible Markup Language (XML) such as Extensible HyperText Markup Language (XHTML). As an example, XHTML data including XForms elements may be received by the application. It is to be understood that the present disclosure is not limited to XHTML with XForms, or even to data formatted in a markup language. For example, client applications other than web browsers may receive server data of a proprietary non-markup language format, then render and display the data according to the requirements of the application.

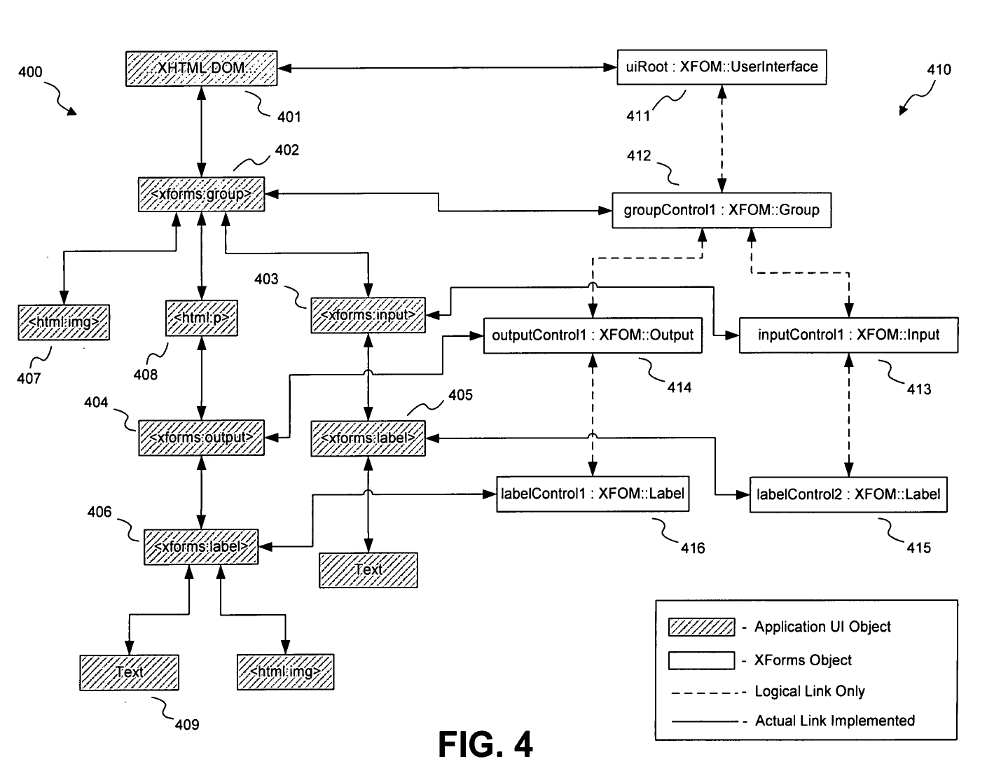

In step 302, the application (e.g., browser) parses the XHTML/XForms data received from the server and generates a set of objects based on the data. Representing user interface components as objects allows the UI components to provide more robust and complex functionality, rather than simply parsing and rendering the data as might be done for simple text blocks. Complex UI components represented as objects may store and persist data and/or provide methods relating to the displayed UI component. The parsing and object generation and event handling may be performed by a Document Object Model (DOM) component installed on the client machine or integrated into the specific client application. In this example, an application UI object may be created for each node in the XHTML/XForms data, and an application UI object hierarchy (e.g., DOM tree or Widget tree) is created based on the child-parent relationships between nodes. An illustrative application UI object hierarchy is shown in FIG. 4 and described in greater detail below.

In step 303, an XForms Object Model API (XFOM) structure is generated mirroring the xforms element objects in the application UI object hierarchy (e.g., DOM tree). That is, an XForms object is created for each object in the application UI object hierarchy corresponding to an xforms element. As described herein, the case-sensitive term “xforms element object” may be used to refer to an object in the application UI object hierarchy corresponding to an XForms element (see hierarchy 400 of FIG. 4), while the case-sensitive term “XForms object” may be used to refer to an object in the XFOM structure (see hierarchy 410 of FIG. 4). The XFOM structure may be organized so that each XForms object has an associated object in application UI object hierarchy. Generating the XFOM structure may be performed concurrently with the creation of the application UI object hierarchy in step 302, for example, by creating and linking an XForms object in the XFOM structure for each xforms element object created in the DOM tree. Alternatively, the XFOM structure may be created subsequent to the creation of the application UI object hierarchy, for example, by traversing the entire DOM tree after it is generated, creating a new XForm object for each xforms element object encountered in the DOM tree, then updating the links of both objects. Note that the non-xforms elements in the application UI object hierarchy might not be represented in the XFOM structure at all. An illustrative XFOM structure is shown in FIG. 4 and described in greater detail below.

In step 304, the client application renders a user interface based on the XHTML/XForms data received from the server, including rendering graphical representations of any xforms element objects in the data. Refer to the World Wide Web Consortium (W3C) published or recommended XForms Specifications (e.g., XForms 1.0 Second Edition) for additional information about specific xforms element objects.

In step 305, UI forms functionality is invoked for the xforms element objects displayed in the user interface. The forms functionality for each xforms element object in the application UI object hierarchy may be provided by the associated XForms object in the XFOM structure 410, rather than by the xforms element object itself. As previously discussed, providing UI functionality in an XFOM structure, rather than directly in the application UI object hierarchy (e.g., DOM tree or Widget tree) may allow for greater reliability and reusability of the UI forms functionality. For example, forms functionality invoked in an application UI object may depend on the DOM implementation used by the application (e.g., browser). Thus, a different client application or browser using a different DOM implementation might not be able to use the same XHTML/XForms data to produce the same functionality. In contrast, by removing the forms functionality from the application UI object hierarchy, the XForms processor may be reused more effectively by different applications with different DOM implementations

Referring to FIG. 4, a block diagram is shown illustrating an object hierarchy relating to a technique for performing forms user interface functionality. More specifically, the illustrative object hierarchy shown includes two distinct object hierarchies: the application UI object hierarchy 400 including application UI objects 401-409, and the XForms object hierarchy, or XFOM structure, 410 including XForms objects 411-416. The application UI object hierarchy 400 may be created based on the XHTML/XForms data received, as described above in step 302 of FIG. 3, while the XFOM structure 410 may be created based on hierarchy 400, either concurrently or subsequently, as described above in step 303 of FIG. 3.

The application UI object hierarchy 400, for example, a DOM tree or Widget tree, is the object hierarchy created from the XHTML/XForms data received by the client computer in step 401. The <xforms:group> application object 402 is the root of a subtree of an XHTML DOM tree 401. The <xforms:group> application object 402 is the parent object to the application objects <html:img> 407, <html:p> 408, and <xforms:input> 403, and so on. The application UI object hierarchy 400 may contain objects corresponding to xforms elements (402, 403, 404, 405, and 406) identified by the “xforms” schema in the node name, simple HTML objects (e.g., 407, 408, 409) identified by the “html” schema in the node name, and other various objects identified by different schemas and node names.

Referring now to the XFOM structure 410, an XForms object is created for each xforms element in the application UI object hierarchy 400. Thus, in this example, during creation of the application UI object hierarchy 400, it may be determined that objects 402-406 represent xforms elements. Accordingly, XForms objects 412-416 may be generated in the XFOM structure 410. Each XForms object may be linked to its associated xforms element object in the application UI object hierarchy 400. In this example, two-way linking pointers may be established in top-level objects 401 and 411, as well as each corresponding xforms element-object pair 402-412, 403-414, 404-414, etc.

The XFOM structure 410 may be implemented with actual links, or alternatively, simply with logical links connecting the different XForms objects 411-416 in the XFOM 410. That is, XForms objects 411-416 in the XFOM structure 410 may each include actual pointers referring to their respective child and parent objects. Alternatively, as shown in FIG. 4, the XForms objects 411-416 might be logically related in a child-parent hierarchical structure (denoted by dotted lines), but might not be actually linked by reference pointers. Potential advantages may result from not actually linking the objects in the XFOM 410. Specifically, it may be understood that the application UI object hierarchy 400, such as a DOM tree, does itself contain actual child-parent object links (denoted by solid lines).

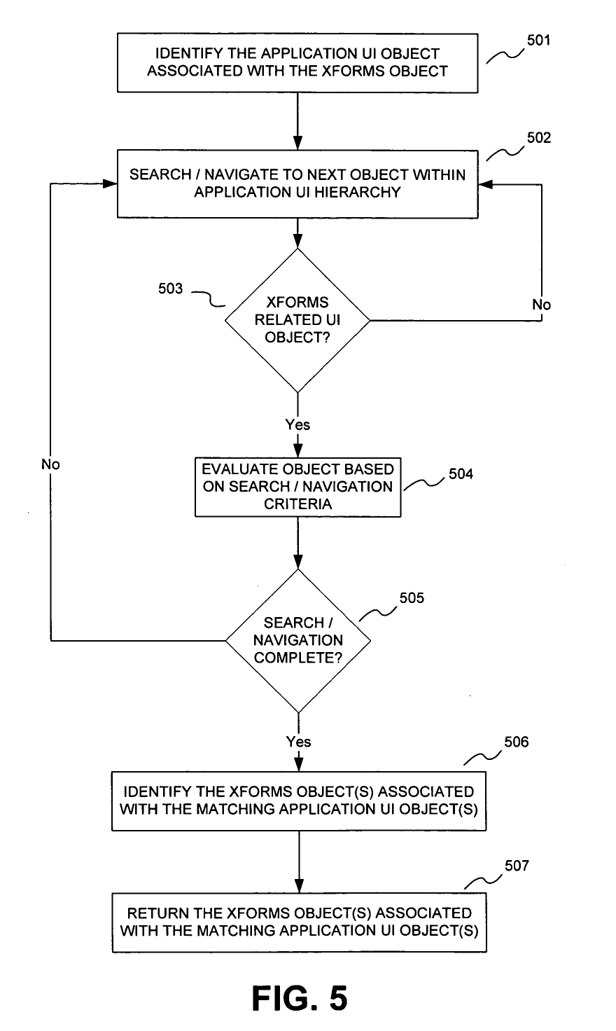

Referring to FIG. 5, a flow diagram is shown illustrating steps for performing a navigation function in an object hierarchy, such as the illustrative object hierarchy shown in FIG. 4. As described above, the XFOM structure 410 might not include actual links between the XForms objects 411-416. Nevertheless, it may be possible to invoke functionality in the XForms objects 411-416 that either depends on information stored by a related XForms object, or invokes functionality in a related object. As an example, certain form controls may need to know their labels. As another example, in XForms the XPath evaluation context may be inherited from parent form object to child form object. In one scenario, a form object is supposed to inherit the XPath evaluation context from its parent form object, and must access the parent form object to read the evaluation context. In another scenario, a form object's XPath evaluation context changes and it must inform all its child form objects of this, because they are supposed to inherit the context. In yet another scenario, a form object representing an input field needs to access its child object which represents the label, so that the label can be correctly displayed next to the input field. Thus, one form object may retrieve data or invoke methods of a related form object, to provide a more robust and coherent user experience.

As described above, this cohesion may be achieved without providing actual links between related objects in the XFOM structure 410. To accomplish this, an XForms object (e.g., inputControl1 object 413) may navigate the logical links to a parent or child XForms objects (e.g., labelControl2 object 415) by communicating with the associated application UI object (e.g., <xforms:input> object 403). The subsequent navigation of the application UI object hierarchy 400 may ignore all of the non-xforms element objects, to identify the correct parent/child object of the XForms object in the XFOM structure. As an example, parent navigation may be performed by navigating upwards in the application UI object hierarchy 400 until encountering an xforms element object, then linking to the corresponding XForms object in the XFOM structure 410. Similarly, child navigation may involve a depth-first search in the application UI object hierarchy 400, in which each XForms element object encountered is considered to be a leaf node. This process is illustrated in the flow diagram shown in FIG. 5, and described in greater detail below.

The steps described in FIG. 5 may occur in response to a search/navigation initiated by an XForms object in the XFOM structure. For example, after receiving a user input in a form field (e.g., a selection in an address ‘State’ dropdown field), the XForms object might invoke a method in a second XForms object to set the possible values for the second object based on the user input (e.g., setting the possible values for the ‘City’ dropdown field based on the chosen state). However, before retrieving data or invoking functionality in a related XForms object, the first XForms object might need to initiate a search/navigation to retrieve a reference link (e.g., pointer) to the relevant XForms object or objects.

In step 501, the associated xforms element object in the application UI object hierarchy 400 is identified. For example, if the XForms object groupcontrol1 412 initiates a query to find all its children, step 501 would involve identifying the associated <xforms:group> object 402.

In step 502, the navigation commences a depth-first search on the objects beneath the associated xforms element object in the application UI object hierarchy 400. Thus, in this example, the <html:img> object 407 may be identified during the child search for XForms object 412.

In step 503, the next object identified in the search/navigation traverse is examined to determine if it is an xforms element object. If the object is not an XForms element object, it is disregarded and the control is returned to step 502 to continue traversal of the hierarchy tree past the object. However, if the object is an xforms element object, it is evaluated in step 504 based on the requested search/navigation. In this example, it may be determined that <html:img> object 407 is not an XForms element object, thus object 407 may be disregarded and navigation may continue beneath the <html:img> object 407 in the hierarchy.

As previously mentioned, the hierarchy search/navigation logic may depend on the specific request or query initiated by an XForms object in the XFOM structure. In this example, the child search initiated by XForms object 412 includes a depth-first on each child of object 402. This traversal reveals that no xforms element objects are present in the sub-tree of <html:img> child object 407. However, traversal of the <html:p> object 408 child sub-tree reveals that the <xforms:output> object 404 is linked to a direct child of XForms object 412. Finally, traversal of the <xforms:input> object 403 child sub-tree will end upon determining that <xforms:input> object 403 is an xforms element object, and thus is linked to a direct child of XForms object 412.

In step 505, it is determined whether the search/navigation in the application UI object hierarchy 400 is complete. For example, in a child search, each sub-tree must be traversed until a child object is found or until every object in the sub-tree has been examined and disregarded. In contrast, a parent search traversal may be terminated after a single parent object is found. Other searches may involve more complex traversals of the hierarchy sub-trees, for example, traversals which include invoking object methods and examining object properties to determine if the current object matches the search/navigation criteria or determine if the search/navigation traversal is complete.

In step 506, once all the matching objects in application UI object hierarchy 400 have been identified, the associated XForms objects in the XFOM structure 410 may be determined using the actual links between the xforms element objects (in the application UI object hierarchy 400) and XForms objects (in the XFOM hierarchy structure 410). In step 507, references to the matching XForms objects are returned to the XForms object that initiated the search/navigation traversal.

According to another aspect of the present disclosure, an XForms object may access its associated application UI object for other purposes besides navigation of logic links to find related XForms objects. XForms objects may also access associated application UI objects to send and retrieve data, and invoke methods useful in providing the forms functionality. Certain information, such as the instances of the form data itself, may be stored by the application UI object rather than the XForms object. Thus, in certain examples, an XForms object may access the application UI xforms element object to control the object properties, update the xforms element object with new data, add or remove items from the xforms element object (e.g., adding or removing items from item sets in an xforms:repeat or xforms:itemset object), or send and receive events associated with the xforms element object.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

1. A method for invoking user interface functionality on a computing device comprising:
receiving a data file comprising markup language data;
creating based on the data file a first object hierarchy comprising a plurality of objects, each corresponding to a user interface component;
identifying in the first object hierarchy a first object corresponding to a user interface component;
creating a second object hierarchy comprising a second object having user interface functionality, said second object associated with said first object;
displaying on the computing device a user interface comprising a graphical representation of the first object; and
invoking the user interface functionality of the second object in relation to the graphical representation of the first object on the displayed user interface.

2. The method of claim 1, wherein each object in the second object hierarchy is associated with an object in the first object hierarchy, each associated object in the first object hierarchy corresponding to a user interface form component.

3. The method of claim 1, further comprising:
after displaying the user interface, receiving user input directed to the user interface component corresponding to the first object;
based on the user input, invoking user interface functionality of the second object, and;
updating the displayed user interface based on said invoked user interface functionality of the second object.

4. The method of claim 3, wherein updating the displayed user interface comprises:
navigating the first object hierarchy to identify a third object in the first object hierarchy, said third object related to said first object, said third object corresponding to a user interface component;
identifying a fourth object in the second object hierarchy associated with the third object;
invoking user interface functionality of the fourth object; and
updating the displayed user interface based on said invoked user interface functionality of the fourth object.

5. The method of claim 1, wherein the first object hierarchy is a Document Object Model (DOM) tree.

6. The method of claim 1, wherein the first object hierarchy is a Widget tree.

7. The method of claim 1, wherein the second object comprises an XForms object.

8. One or more computer readable media storing computer-executable instructions which, when executed on a computer system, perform a method comprising:
receiving a data file comprising markup language data;
creating based on the data file a first object hierarchy comprising a plurality of objects, each corresponding to a user interface component;
identifying in the first object hierarchy a first object corresponding to a user interface component;
creating a second object hierarchy comprising a second object having user interface functionality, said second object associated with said first object;
displaying on the computing device a user interface comprising a graphical representation of the first object; and
invoking the user interface functionality of the second object in relation to the graphical representation of the first object on the displayed user interface.

9. The computer readable media of claim 8, wherein each object in the second object hierarchy is associated with an object in the first object hierarchy, each associated object in the first object hierarchy corresponding to a user interface form component.

10. The computer readable media of claim 8, the method further comprising:
after displaying the user interface, receiving user input directed to the user interface component corresponding to the first object;
based on the user input, invoking user interface functionality of the second object, and;
updating the displayed user interface based on said invoked user interface functionality of the second object.

11. The computer readable media of claim 10, wherein updating the displayed user interface comprises:
navigating the first object hierarchy to identify a third object in the first object hierarchy, said third object related to said first object, said third object corresponding to a user interface component;
identifying a fourth object in the second object hierarchy associated with the third object;
invoking user interface functionality of the fourth object; and
updating the displayed user interface based on said invoked user interface functionality of the fourth object.

12. The computer readable media of claim 8, wherein the first object hierarchy is a DOM tree.

13. The computer readable media of claim 8, wherein the first object hierarchy is a Widget tree.

14. The computer readable media of claim 8, wherein the second object comprises an XForms object.

15. An electronic device comprising:
a display screen;
a processor controlling at least some operations of the mobile terminal;
a memory storing computer executable instructions that, when executed by the processor, cause the mobile terminal to perform a method for displaying a user interface on the display screen, said method comprising:
receiving Extensible Markup Language (XML) data;
creating based on the XML data a first hierarchy comprising a plurality of software objects, each corresponding to a user interface component;
creating a second hierarchy comprising a plurality of XForms objects;
displaying on the display screen a graphical representation of a first software object in the first hierarchy;
identifying in the second software object hierarchy a first XForms object associated with the first software object; and
invoking a method of the first XForms object in relation to the displayed first software object.

16. The electronic device of claim 15, wherein each XForms object in the second hierarchy is associated with an object in the first hierarchy, and wherein each associated object in the first hierarchy corresponds to a user interface form component.

17. The electronic device of claim 15, further comprising:
receiving input from a user of the mobile terminal directed to the user interface component associated with the first software object;
based on the input, invoking a method of the first XForms object; and
updating the graphical representation of the first software object displayed on the display screen based on the return value from the XForms object method invoked.

18. The electronic device of claim 15, wherein the first object hierarchy is a Widget tree.

19. The electronic device of claim 15, wherein the first software object hierarchy is a DOM tree.

20. The electronic device of claim 15, wherein the method is performed by the processor without a DOM implementation installed in the memory.

21. An electronic device having means for performing user interface functionality, said computing device comprising:
means for receiving a data file comprising markup language data;
means for creating based on the data file a first object hierarchy comprising a plurality of objects, each corresponding to a user interface component;
means for identifying in the first object hierarchy a first object corresponding to a user interface component;
means for creating a second object hierarchy comprising a second object having user interface functionality, said second object associated with said first object;
means for displaying on the computing device a user interface comprising a graphical representation of the first object; and
means for invoking the user interface functionality of the second object in relation to the graphical representation of the first object on the displayed user interface.

22. The electronic device of claim 21, wherein the means creating the second object hierarchy associates each object in the second object hierarchy with an object in the first object hierarchy, wherein each associated object in the first object hierarchy corresponds to a user interface form component.

23. The electronic device of claim 21, wherein the means for creating the first object hierarchy and means for creating the second object hierarchy do not invoke a DOM implementation installed in the memory of the computing device.
